(19) United States
(12) Patent Application Publication
(10) Pub. No.: US 2008/0174791 A1
(43) Pub. Date: Jul. 24, 2008

(54) Position detection device, rotating body detection control device, rotating body trael device and image forming device

(76) Inventor: Koichi Kudo, Yokohama-shi (JP)

Correspondence Address: DICKSTEIN SHAPIRO LLP, 1825 EYE STREET NW, Washington, DC, 20006-5403, US

(21) Appl. No.: 12/003,242

(22) Filed: Dec. 21, 2007

(30) Foreign Application Priority Data
Dec. 21, 2006 (JP) 2006-345052

(51) Int. Cl. G06K 1/00

(52) U.S. Cl. 358/1.5

(57) ABSTRACT

A position detection device, includes a scale; and an image pickup device which is configured to capture a mark pattern of the scale formed with a consecutive mark pattern generated by a change in prescribed reflectivity or permeability, the mark pattern of the scale being formed with substantially identical mark patterns which are disposed in a main moving direction of the scale continuously, and the mark pattern being arranged such that a part of the mark pattern in a sub moving direction intersecting with the main moving direction is projected, when the mark pattern is projected on the image pickup device, the position detection device being configured to detect a moving position of the scale by capturing the mark pattern of the scale with the image pickup device.

### BACKGROUND OF THE INVENTION

1. Field of the Invention

The present invention relates to an image forming device. The image forming device is used in a digital copy machine or the like which includes movable bodies such as a photoreceptor drum and an intermediate transfer belt, and transfers a toner image developed on the photoreceptor drum to the movable bodies or the like. In particular, the invention relates to a position detection device which is configured to measure displacement of a rotating body in the image forming device.

2. Description of the Related Art

It is generally known in such an image forming device that an image carrier such as a photoreceptor drum and a movable body such as an intermediate transfer belt are brought into contact with each other to form a transfer nip, and with each surface of the image carrier and the movable body being moved in a forward direction mutually, a toner image developed on the photoreceptor drum is transferred from the image carrier to the movable body. Instead of the intermediate transfer belt, a recording medium carrier belt can be used as the movable body.

When the former intermediate transfer belt is used, the toner image is transferred from the image carrier to the intermediate transfer belt at the transfer nip by a first transfer, and then is carried to a second transfer position, and at this position the image is finally transferred from the intermediate transfer belt to a recording medium such as decalcomania paper.

In addition, when the latter recording medium carrier belt is used, the toner image is directly transferred from the image carrier to the recording medium on the recording medium carrier belt, without being intermediately transferred to the recording medium carrier belt. There is no difference in how the toner image is transferred from the image carrier side to the movable body side at the transfer nip, regardless of which movable body is used.

In such an image forming device which includes the movable body, a problem arises in that the toner image is not transferred accurately to a correct position of the movable body or the recording medium carried by the movable body, and transfer displacement occurs. In particular, in a full color image forming device in which each color toner image formed on an image carrier is superimposed sequentially and transferred, the transfer displacement results in a color shift due to a shift of each color toner image, and the color tone of the image is disturbed.

Therefore, to eliminate such transfer displacement, various technologies to control the moving speed of the belt at a constant speed have been developed.

JP 2004-205308 A discloses a displacement measurement device, as a conventional technology of displacement measurement which uses image data. In the displacement measurement device, an amount of displacement of an object is measured optically, and at least an illumination system and an imaging optical system are attached to a common base, the illumination system having a light guide which transmits output light of a light source and a collective lens which focuses the output light of the light guide and irradiates the object, the imaging optical system imaging reflected light of the object to a light receiving sensor surface.

JP 2004-117010 A discloses a displacement measurement device which includes: an illumination system which irradiates light to an object; an imaging optical system which sends reflected light of the object to an image sensor section; a signal processing section which computes an amount of displacement of the object according to an output signal of the image sensor section; a focus computing section which computes a focus status of the image optical system according to the output signal of the image sensor section; and a display section which displays a computing result of the focus computing section.

In JP 2003-076486 A, a technology is disclosed such that pixel data concerning a part of a surface is loaded into a buffer memory which shifts data of a position between consecutive positions in the buffer memory, when each pixel of a comparison frame is processed and cross-correlation is calculated, and autocorrelation concerning a position in a standard frame is determined and used together with a result of the cross-correlation, and then sub-pixel interpolation concerning a movement of a pointing device is determined, the pointing device is moved sufficiently, and as a result, a new standard frame is loaded by using data concerning the compared frame being processed now when a next compared frame does not overlap with the existing standard frame.

In JP 2003-222505 A, a technology is disclosed such that a first error function of a standard image is acquired, and the first error function is high-resolution-processed by interpolation computing, and then a second error function of the standard image and an image to be measured is acquired, and further a third error function of the second error function and the first error function of the standard image after being high-resolution-processed is computed, and a shift length of the standard image and the image to be measured is obtained from the third error function, and then displacement is calculated from the shift length.

In JP 2003-222504 A, a technology is disclosed such that an optical magnification acquiring displacement from a shift length is set to be a function of which the shift length is a parameter, and when a preparation condition of switching a standard image is established, a standard image candidate is set, and an amount corresponding to a distance between the standard image and the standard image candidate is measured many times, and then the standard image candidate is set as a new standard image, after adding an average value of the amount corresponding to the distance to a position of the standard image.

JP H1-287725 A discloses a device which is configured to specify a position. The device includes: a movable body which is movable relative to an object surface; an electromagnetic source which is provided in the movable body and irradiates coherent electromagnetic waves from a prescribed part of the movable body to the object surface; a speckle movement detection device which is provided in the movable body and detects relative displacement data of a speckle pattern generated from the object surface with irradiation of the electromagnetic waves, relative to the movable body; and a re-diffracting optical system which is disposed between the object surface irradiated by the electromagnetic waves and the speckle movement detection device, the device specifying a position based on the relative movement information detected by the speckle movement detection device.

In JP H10-281811 A, a technology is disclosed such that a line sensor is arranged along a radium of a disk with its longer direction and is fixed, a position of a curve viewed by the line sensor is moved in the radium direction by rotation of the disk, and a consecutive angle or an angle speed obtained by jumping a certain size window between curves is possible to be measured by setting a pattern formed by repetition of the curve to be overlapped when viewed from the longer direction of the line sensor, and a circle pattern is provided at a position at which the line sensor is able to capture it together with the curve, displacement of the circle pattern is detected and an amount of eccentric from a rotation center of the disk is detected and a change in gravity of the curve resulting from the eccentric is compensated, and then a rotating angle or an angle speed of the disk is computed from a movement of the gravity compensated.

JP 2004-21236 A discloses an image forming device which is configured to detect a moving speed of an endless belt which carries paper or a toner image and is provided with a plurality of marks at a prescribed interval, and control the moving speed to be constant, and control displacement of transfer to the paper of the toner image or the endless belt. The image forming device includes a control device which is configured to detect a moving speed of the marks, and compute to obtain a control amount of the belt reaching a target speed set preliminarily according to the moving speed, and then control the speed of the belt with the control amount until reaching a next mark.

The above-mentioned technologies arc related to displacement measurement using an image sensor, and the technologies are used for such as a displacement measuring device and an optical mouse device. The measuring principle involves a mechanism in which for an image captured by the image sensor, relating to a previous image and a present captured image, an image captured last time is shifted pixel by pixel to calculate autocorrelation, and a position at which a correlation coefficient is highest is recognized as a moved position.

In the above-mentioned methods, since it is possible to carry out a measurement if an image pattern on a detection surface is obtained, even if a standard scale is not used which is different with such as a normal encoder, the measurement with a single detector is possible and thus it is convenient.

In addition, while in an encoder which uses a scale, data is not updated if a signal edge is not incremented, due to position data being updated per sampling, useless time is negligible and real time is highly achieved.

However, problems as follows arise at the same time.

1. Due to an amount of light received being divided by a number of pixels in an image pickup device, the amount of light received in one pixel is small, and noise increases. Moreover, it is necessary to increase the amount of illuminating light and then a light source with high-power is needed, when S/N is desired to be improved.

2. In a moving-position detection which uses correlation of an image, it is necessary to calculate a correlation coefficient for all pixels, and thus a large calculation amount is needed, and a measurement in real time is difficult.

3. When a summation moving distance is needed, measuring error accumulates due to summation of the relative moving distance of each sample being necessary. Moreover, when a position measurement with a high accuracy is needed, it is necessary to increase the number of pixels and the calculation amount increases further.

For the problem indicated in the above-mentioned item 3, in the rotary encoder disclosed in IP H10-281811 A, due to an image of an inclining line moving on the line sensor in a direction of the line according to the rotation of the disk, the rotation angle of the disk is detected with pixel-wise resolution of the line sensor, thus it is possible to perform the rotation detection with a high resolution, even by a line sensor having a rough pixel pitch.

However, for the method disclosed in JP H10-281811 A, a problem arises in that if an eccentric scale of the rotary encoder exists, a movement in an eccentric direction is detected as a movement in the rotation direction.

For the problems existing in the conventional technologies, such a method is proposed in which a circle line pattern is formed in a rotation direction of a disk, and then eccentric of the disk is detected to correct, by capturing the circle line pattern and other pattern with the same line sensor. However, due to a lack of the line or accuracy problems in the detection method where one line is detected, it is difficult to measure an accurate position.

Moreover, it is necessary to perform image processing of eccentric detection besides the movement of the scale, thus there is a problem of an increment of computing load for the measurement.

### SUMMARY OF THE INVENTION

At least an object of the present invention is to provide a position detection device which simultaneously performs position detections in a moving direction of a scale and a direction intersecting, for example, perpendicular to the moving direction, by comparing an amount of light received by an image pickup device from a scale pattern. With the position detection device according to the present invention, it is possible to perform the position measurement stably with a high speed and a high accuracy.

In light of the above, the present invention proposes, for example, a position detection device which includes:

### BRIEF DESCRIPTION OF THE DRAWINGS

The invention will be described further below with reference to embodiments and the accompanying schematic drawings, in which:

FIG. 1 is a schematic view of a major part of an intermediate transfer belt carrier device according to an embodiment of the invention;

FIG. 2 is a structural view of a full color image forming apparatus provided with an intermediate transfer belt carrier device 1 illustrated in FIG. 1 according to another embodiment of the invention;

FIG. 3 is a plan view of an endless belt 3 illustrated in FIG. 1;

FIG. 4 is a circuit block view of a position detection device in the intermediate transfer belt carrier device 1 illustrated in FIG. 1;

FIG. 5 is a plan view showing an arrangement of an image pickup device which is arranged parallel to a moving direction of a scale and the whole of a scale mark is imaged on the image pickup device;

FIG. 6 is a plan view showing an arrangement of an image pickup device which is arranged such that only a part of the scale mark in a sub moving direction is projected on the image pickup device according to a further embodiment of the present invention;

FIGS. 7A to 7C are graph charts each of which illustrates data obtained by the image pickup device, a signal processing section, and a position computing section of the position detection device respectively, according to a further embodiment of the present invention;

FIGS. 8A to 8C are graph charts each of which illustrates a condition at which mark center position data calculated by the signal processing section moves by a movement of the scale according to a further embodiment of the present invention;

FIG. 9A is a view illustrating a layout of the scale and the image pickup device on the belt, and FIG. 9B is a view illustrating a positional relationship of a mark pattern and the image pickup device in one case, and FIG. 9C is a view illustrating a positional relationship of the mark pattern and the image pickup device in another case according to a further embodiment of the present invention;

FIG. 10 is a graph chart illustrating a condition at which the strength of a signal obtained from the image pickup device increases or decreases according to an approach position (the sub moving direction) of the belt, according to a further embodiment of the present invention;

FIGS. 11A and 11B are schematic structure views of another embodiment of the position detection device in the intermediate transfer belt carrier device according to the present invention.

FIGS. 12A to 12C are graph charts each of which illustrates a signal obtained by the two image pickup devices illustrated in FIG. 11;

FIGS. 13A and 133B are schematic structure views of a further embodiment of the position detection device in the intermediate transfer belt carrier device according to the present invention.

FIG. 14A illustrates a mark pattern projected on a two-dimensional image sensor, and FIG. 14B illustrates the strength of light received or a density distribution after being averaged in an x direction of the two-dimensional sensor, according to a further embodiment of the present invention.

FIG. 15 is a schematic structure view of a further embodiment of the position detection device in the intermediate transfer belt carrier device according to the present invention.

FIG. 16 is a view illustrating a disc-shaped scale which is used as a rotary encoder according to a further embodiment of the present invention; and

FIG. 17 is a schematic structure view of a further embodiment of the position detection device in the intermediate transfer belt carrier device according to the present invention.

### DETAILED DESCRIPTION OF THE PREFERRED EMBODIMENTS

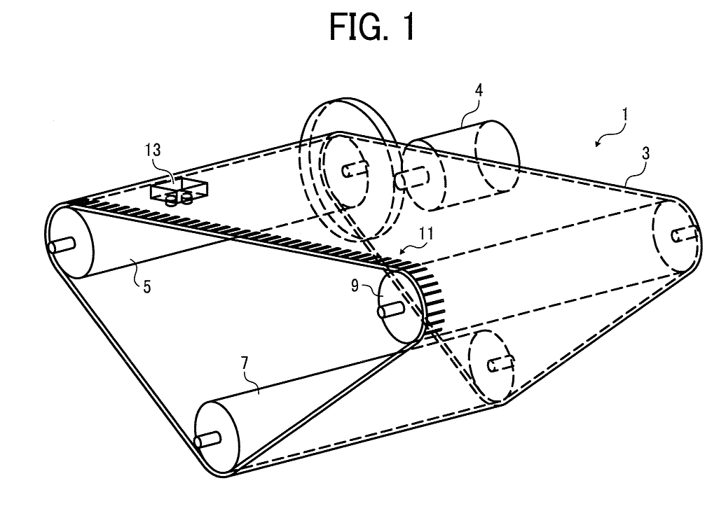

As illustrated in FIG. 1, in an intermediate transfer belt carrier device (an endless belt carrier device) 1, an endless belt 3 is wound on a drive roller 5 and two driven rollers 7 and 9, and is driven in a prescribed direction (a main moving direction) by the drive roller 5. The drive roller 5 is driven by a drive motor 4.

A scale 11 is provided at an end part of the endless belt 3. The scale 11 is formed with a consecutive mark pattern generated by a change in the prescribed reflectivity or permeability. A light source 21 (refer to FIG. 4) and an image pickup device 13 which capture the mark pattern of the scale 11 are disposed at a position opposed to the scale 11. The scale 11, the light source 21, and the image pickup device 13 form a part of a position detection device of an embodiment according to the present invention.

The image pickup device 13 includes a line sensor having a plurality of light receiving elements arranged continuously. The image pickup device 13 is structured such that an arrangement direction of the light receiving elements of the line sensor is substantially identical to the main moving direction of the scale 11 (refer to FIG. 6). Therefore, detection in a sub moving direction can be performed easily even with a low-cost line sensor of one-dimension as the image pickup device.

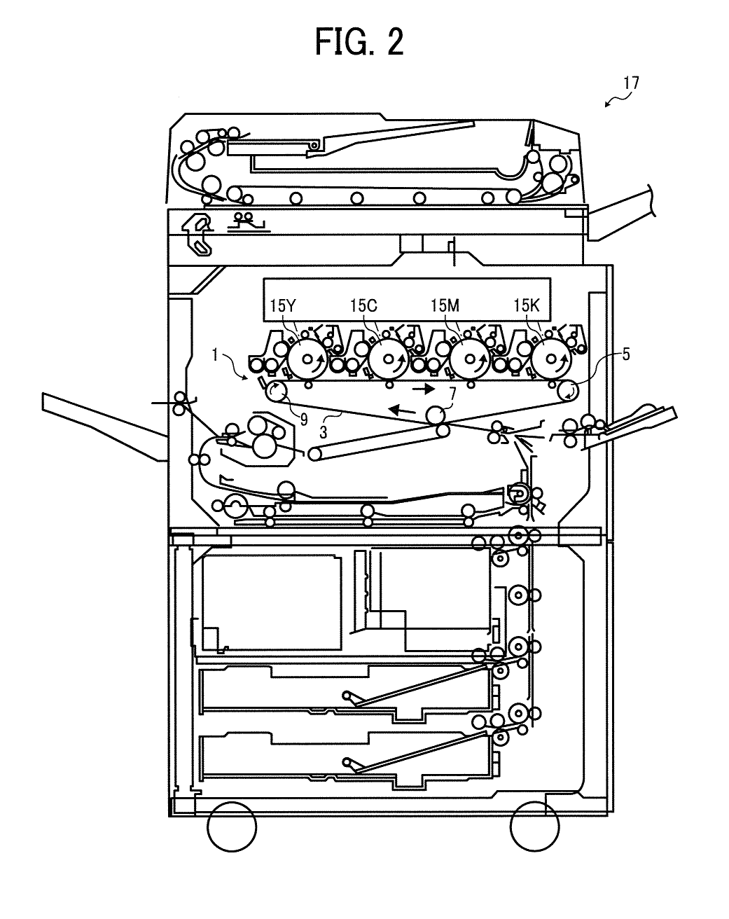

As illustrated in FIG. 2, the intermediate transfer belt carrier device 1 is fitted in a full color image forming apparatus 17 or the like, a plurality of image forming devices 15 being disposed with a structure known as a tandem configuration in the full color image forming apparatus 17, and a color toner image being superimposed sequentially. The intermediate transfer belt carrier device 1 retains each color toner image temporarily and superimposes each image and then transfers the images to paper.

In recent years, due to the full color image forming apparatus adopting such a method in which the plurality of image forming devices 15 are disposed with the structure which is called the tandem configuration and the color toner images are superimposed sequentially, an irregular speed of the intermediate transfer belt carrier device 1 affects precise color registration, and results in the image quality degradation. It is possible to measure a speed of a belt surface directly and perform a feedback control on the drive motor 4, to make the surface speed of the endless belt 3 constant, but it is difficult to measure a belt-shaped surface with a high accuracy by a general measuring device. The present invention provides a device by which the speed of the belt-shaped surface can be measured with a high accuracy.

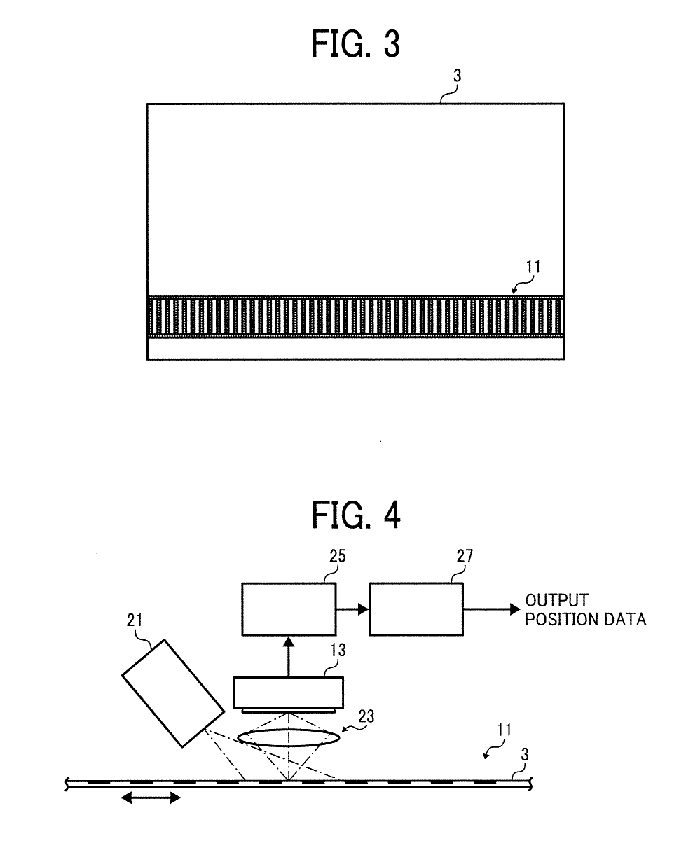

FIG. 3 is a plan view of the endless belt 3 illustrated in FIG. 1, the scale 11 which includes a reflective mark across a round along a transfer direction of the belt 3 is used, and due to a color being applied to the intermediate transfer belt carrier device in the image forming device, the scale 11 is disposed at an end of the belt 3, away from a center part which retains a toner image.

It is possible to use a plurality of white line patterns or the like for a black ground as illustrated in FIG. 3, as a mark pattern of the scale 11. The mark having different reflectivity or permeability with a base material includes a plurality of line patterns each of which has a certain width, the plurality of line patterns being consecutive at a constant frequency.

Thus, it is possible to make a measurement with a good accuracy, and without irregular signal strength in the sub moving direction, by using the line pattern having the certain width.

In addition, since as the mark pattern a pattern which has a variation in the amount of light received when taking an image by the image pickup device can be used, a metallized total reflecting pattern or a transmissive pattern like a metallic slit is able to be used as the mark pattern.

Moreover, CCD is generally used as the image pickup device 13, but a C-MOS sensor or the like can also be used. When the pixel array is one-dimensional device, it is possible to use it such that the pixels are arranged in the arranging direction of the scale, in addition, a two-dimensional device can be used. Furthermore, if an imaging lens is disposed in front of the image pickup device 13 and the mark on the scale is imaged, at this time, when the scale is illuminated by an illuminating device as necessary, light receiving efficiency is good and a signal with a high S/N ratio is obtained.

As illustrated in FIG. 4, reflected light of light irradiated from a light source 21 to the scale 11, reaches the image pickup device 13 through an imaging lens 23, and data obtained at the image pickup device 13 which receives light is converted into a position measurement data by a signal processing section 25.

Here, when a CCD is used as the image pickup device 13, due to an analog signal synchronized with a clock signal being output, sampling is performed at a sampling period corresponding to a necessary resolution and A/D conversion is carried out. When a C-MOS sensor is used as the image pickup device 13, since data is extracted by addressing of pixels, scanning is carried out sequentially and data is extracted.

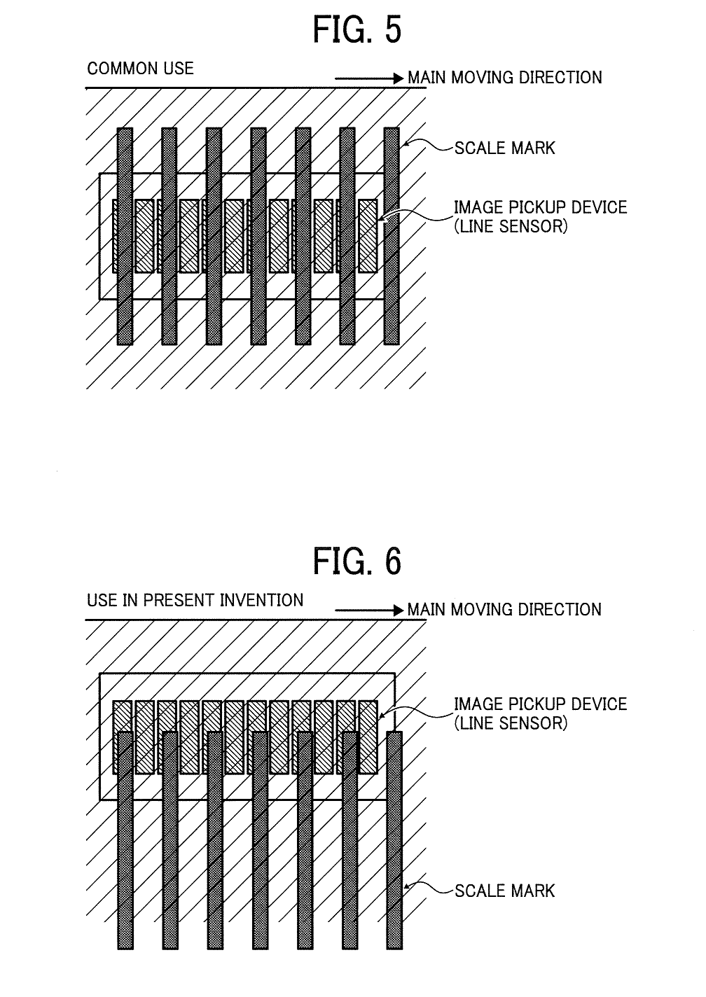

Here, generally, an image pickup device is arranged such that it is parallel to a moving direction of a scale and the whole of a scale mark is imaged on the image pickup device, as illustrated in FIG. 5, to detect a scale pattern. In an embodiment of the present invention, as illustrated in FIG. 6, the image pickup device 13 is arranged such that only a part of a mark pattern in its sub moving direction is projected on the image pickup device 13.

That is, the mark pattern of the scale 11 includes substantially identical mark patterns which are disposed in the main moving direction of the scale 11 continuously, and the mark pattern is arranged such that a part of the mark pattern in the sub moving direction intersecting, for example, perpendicular to the main moving direction is projected, when the mark pattern is projected on the image pickup device 13.

As a result, detection in the sub moving direction can be carried out easily by comparing an amount of light received.

Next, operations of the position detection device in the intermediate transfer belt carrier device having the above-mentioned structure will be explained.

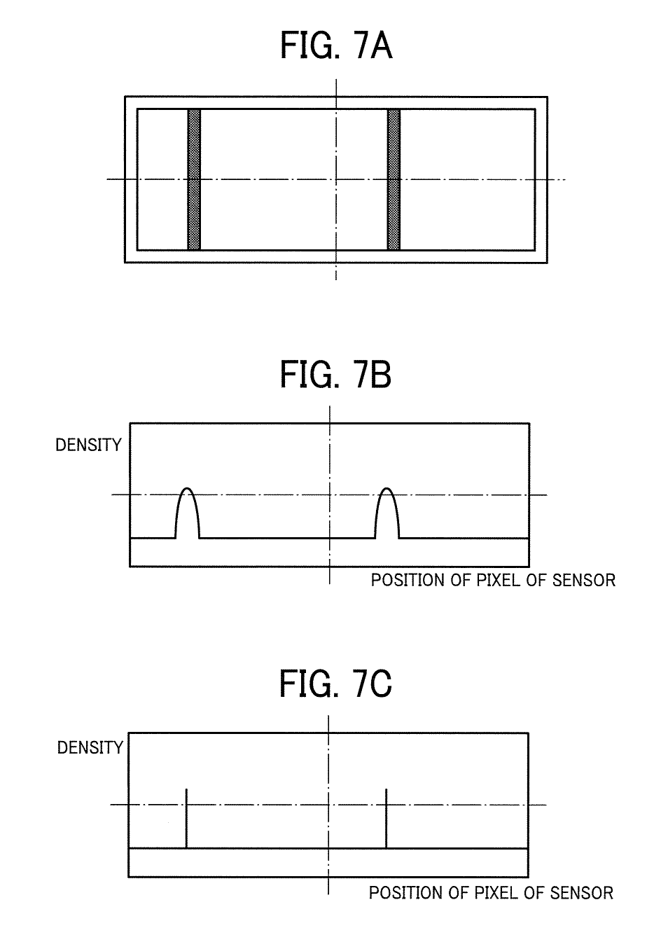

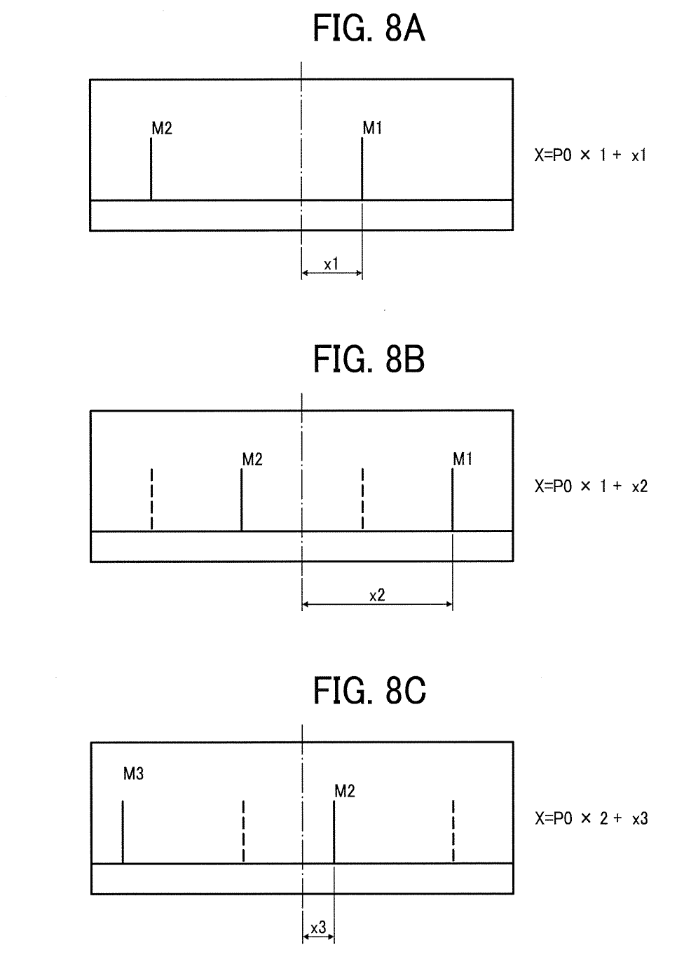

Detection in the main moving direction is measured by measuring a movement of the pattern by sampling at a certain time period. The movement of the pattern can be obtained by calculating a correlation, and it is also possible to measure the movement of the pattern by calculating the position of the mark if the mark pattern having a certain period is used. These methods will be explained briefly with reference to FIGS. 7A to 7C and 8A to 8C.

As illustrated in FIG. 7A, data of a projective image obtained at the image pickup device 13 is sent to the signal processing section 25, and as illustrated in FIG. 7B, the data is converted to density data corresponding to an amount of light received, and then mark center data which is obtained by extracting a center position of the mark from the density data, as illustrated in FIG. 7C, is sent to a position computing section 27. It is possible to obtain the center position of the mark by a method of setting a threshold level and acquiring a center of a rising edge and a negative-going edge, and a method of acquiring a center of the density, etc.

FIGS. 8A to 8C are graph charts each of which illustrates a condition at which the mark center position data calculated by the signal processing section 25 moves by a movement of the scale according to a further embodiment of the present invention.

In FIG. 8A to 8C, M1 and M2 are center positions of the mark. As illustrated in FIGS. 8A to 8C, it is possible to calculate a moving distance X according to the following formula:

X=P×N+x

wherein N represents a mark count value which counts whether the mark passes over a standard position or not, P represents a pitch of the mark, and x represents a mark position from the standard position in the image sensor.

In a method of calculating the image correlation, it is necessary to calculate the correlation with data in which the pixel is shifted only by a quantity possible of moving, and the calculation amount is large, while in the method according to the present invention, it is possible to measure the movement of the scale by a relatively small calculation amount.

The measuring method in the main moving direction is explained above. According to a further embodiment of the present invention, in addition to the measurement in the main moving direction, a measurement in the sub moving direction is carried out, and further, any method can be used to make the measurement in the main moving direction.

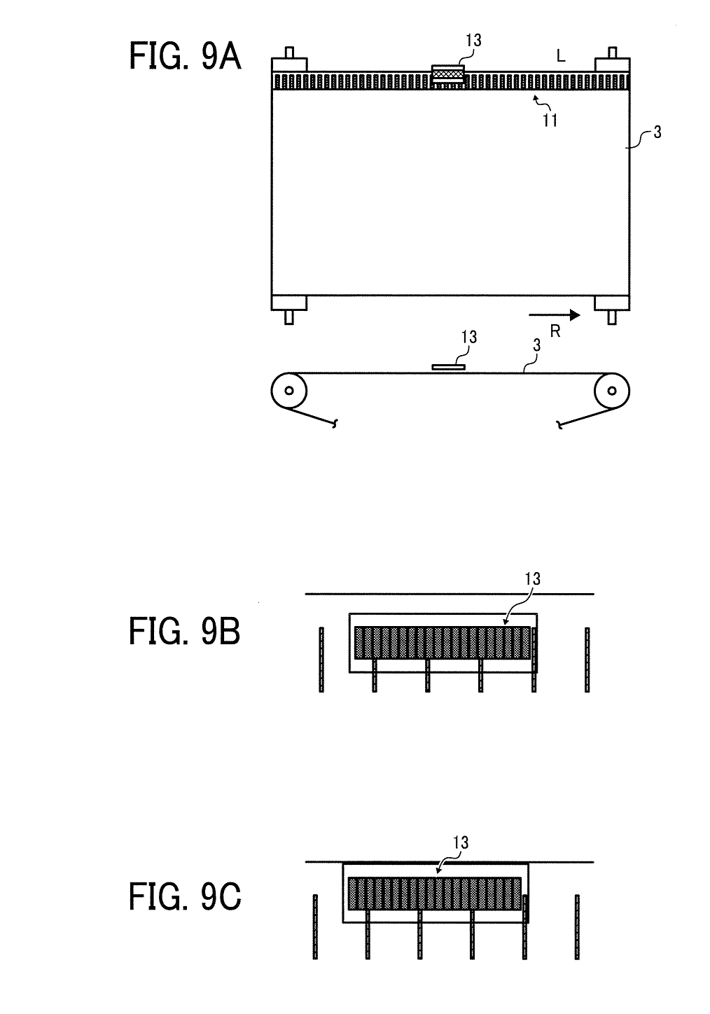

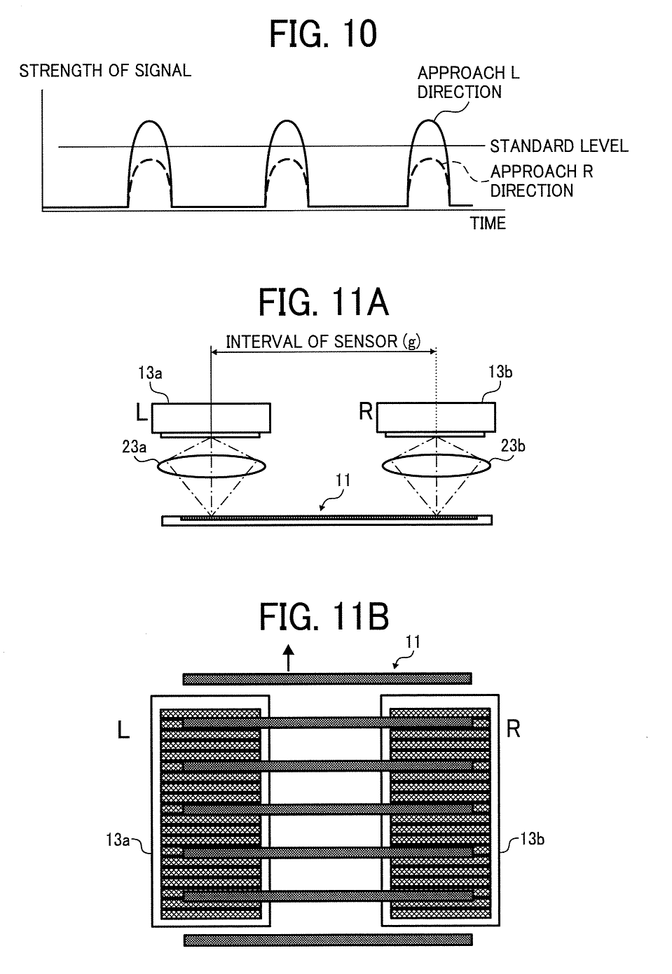

Hereafter, an embodiment of detection in the sub moving direction will be explained with reference to FIGS. 9A to 9C and 10.

FIG. 9A illustrates a layout of the scale 11 and the image pickup device 13 on the belt 3, according to a further embodiment of the present invention. In the present embodiment, the image pickup device 13 is arranged to protrude from a belt edge side having the mark pattern. Each of FIGS. 9D and 9C illustrates a position relationship of the mark pattern and the image pickup device 13 at this time.

Here, for the endless belt carrier device illustrated, the sub moving direction indicates an approach direction. For example, as illustrated in FIG. 9A, when the endless belt approaches an upper side (an L side) in FIG. 9A, a majority of the mark pattern of the scale is projected on the image pickup device 13, and an image of the mark pattern is presented in nearly the whole area in a width direction of the line sensor of the image pickup device 13, as illustrated in FIG. 9B. On the other hand, when the endless belt approaches a lower side (an f side) in FIG. 9A, a part of the mark pattern is projected on the image pickup device 13, as illustrated in FIG. 9C, and the image of the mark pattern is not presented in the whole area in the width direction of the line sensor, and density of light received by the line sensor decreases, FIG. 10 illustrates signals output from the image pickup device 13 at this time. Strength of the signal obtained from the image pickup device 13 increases or decreases according to an approach position of the belt (a position of the sub moving direction), as illustrated in FIG. 10. The position of the sub moving direction can be detected by analyzing the strength of the signal obtained from the image pickup device 13.

Next, a further embodiment of the position detection device in the intermediate transfer belt carrier device according to the present invention will be explained.

According to this embodiment, two image pickup devices 13a and 13b are provided to detect both ends in the sub moving direction of the mark pattern.

In the present embodiment, as illustrated in FIGS. 11A and 11B, a first objective lens 23a and a first image pickup device 13a, and a second objective lens 23b and a second image pickup device 13b, are arranged at a sensor interval (g) which is a little shorter than a length of the mark pattern.

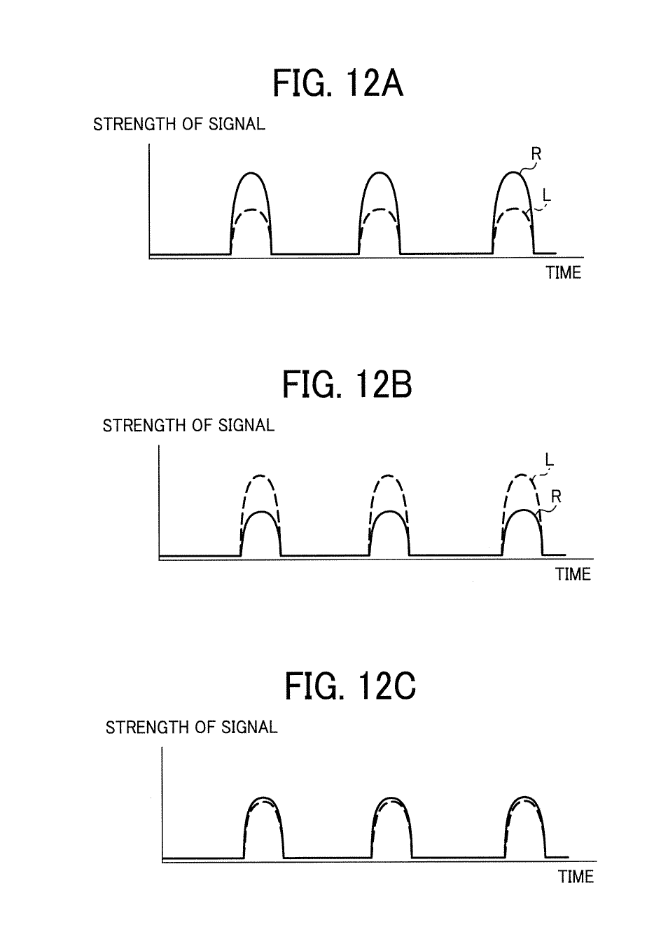

FIGS. 12A to 12C illustrate graph charts of a signal obtained by the two image pickup devices 13a and 13b. FIG. 12A illustrates a condition when the endless belt approaches the R side (an R signal), and 1253 illustrates a condition when the endless belt approaches the L side (an L signal), and 12C illustrates a condition when the endless belt is at a position not approaching the R side or the L side.

Here, each of the two signals changes in an opposite direction mutually, and if a difference signal between the R signal and the L signal is obtained, a signal with high sensitivity is obtained. Moreover, an approach control with a high sensitivity and a high accuracy can be performed by controlling the difference signal to 0 when using it for the approach control.

Next, a further embodiment of the position detection device in the intermediate transfer belt carrier device according to the present invention will be explained.

In the present embodiment, the image pickup device 13 includes at least two areas in the sub moving direction, and images of both ends of the mark pattern are captured optically by the image pickup device 13.

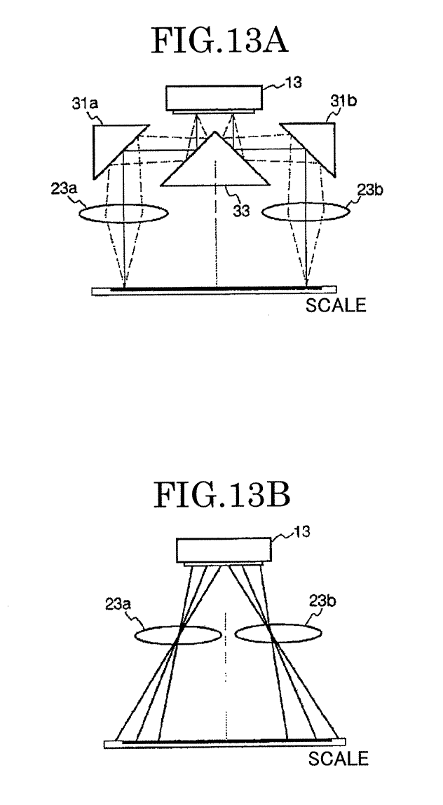

As illustrated in FIG. 13A, in the present embodiment, both ends of the mark pattern which are away from each other, are projected on the adjacent image pickup device 13 with the use of two mirrors 31a and 31b.

In addition, as illustrated in FIG. 13B, it is possible to employ such a structure in which positions or angles of the lens 23a and the lens 23b are adjusted to image both ends of the scale.

Next, a further embodiment of the position detection device in the intermediate transfer belt carrier device according to the present invention will be explained.

In the present embodiment, a two-dimensional image sensor is used as the image pickup device 13. The two-dimensional image sensor 13 has a size which is able to image a range larger than a length of the mark pattern in the sub moving direction. It is also possible to utilize an optical system such as a lens to expand a capture range to project when the image pickup device is small, to achieve a similar effect.

Therefore, even if the two-dimensional sensor 13 is employed, it is possible to decrease the calculation amount and perform a high-speed measurement by using a sum of an amount of light received of pixels located from a center to right and left sides.

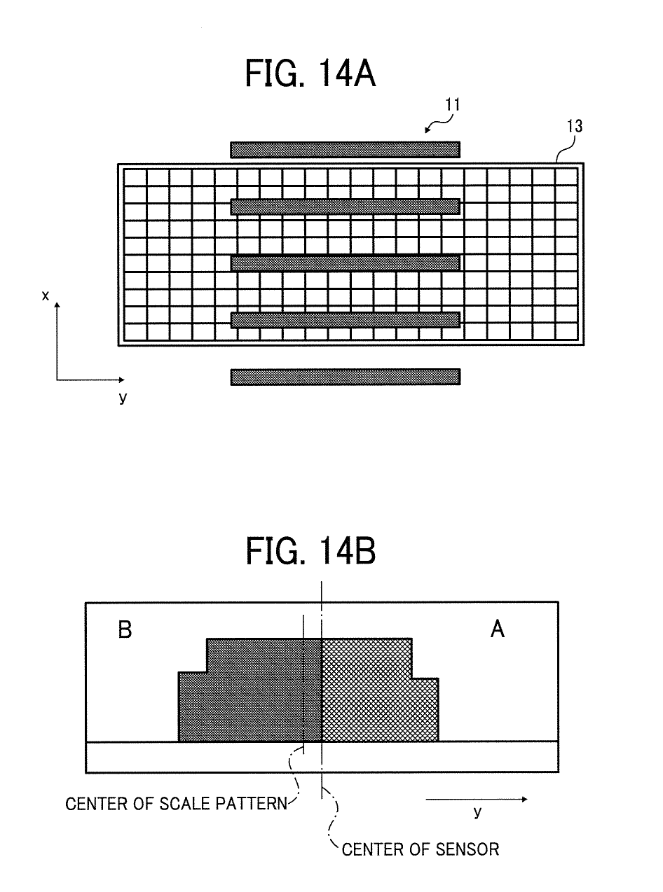

FIG. 14A illustrates a mark pattern projected on the two-dimensional image sensor 13, and FIG. 14B illustrates a strength of light received or a density distribution after being averaged in an x direction of the two-dimensional sensor 13. As illustrated in FIG. 14B, when the pattern shifts in a direction of B only a little, strength on the B side from a center line of the image pickup device 13 become strong. It is necessary to carry out a certain amount of arithmetic processing to calculate a center position of the scale pattern, while to obtain the strength of each of right and left sides from the center line of the image pickup device 13, it is possible to simply accumulate in each region. Thus, the position of the mark pattern can be measured easily by comparing the strength of A area with that of B area.

Next, a further embodiment of the position detection device in the intermediate transfer belt carrier device according to the present invention will be explained.

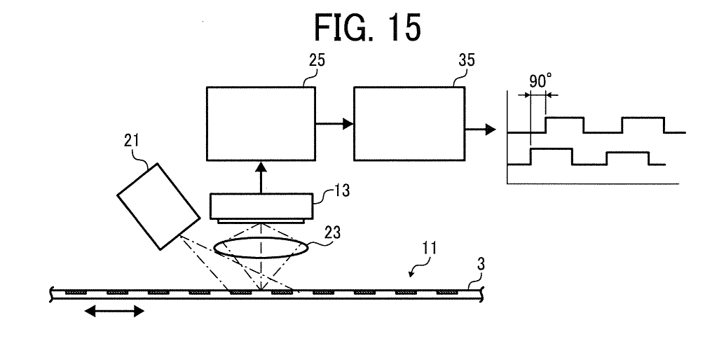

In the present embodiment, a commonly used encoder sensor can be replaced, by performing signal processing on output of the line sensor and outputting pulse signal of an AB phase with a phase difference of 90 degrees. As illustrated in FIG. 15, a pulse generation section 35 is provided after the signal processing section 25, to generate the AB phase pulse.

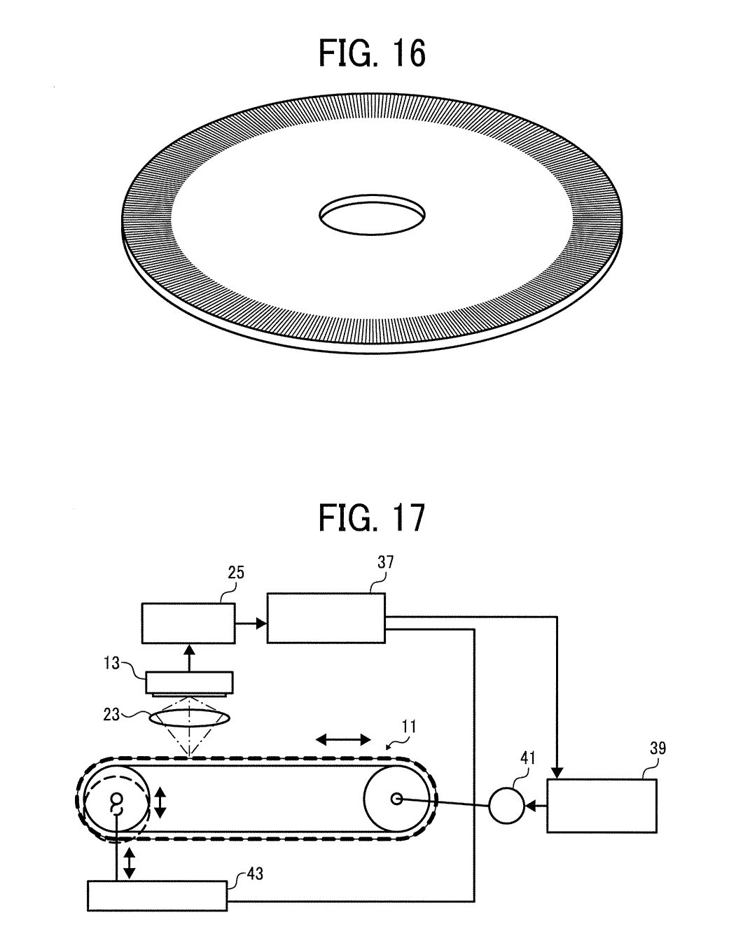

Moreover, this invention is applicable to a rotary encoder. That is, it is possible to use a disk-shaped scale as illustrated in FIG. 16 in the present invention.

Next, a further embodiment of the position detection device in the intermediate transfer belt carrier device according to the present invention will be explained.

In the present embodiment, a control device is provided which is configured to detect a position and speed of the rotating body from an output of the position detection device and control a drive device.

In the belt carrier device as illustrated in FIG. 17, a rotation control of the belt 3 and a thrust adjustment can be carried out simultaneously, by controlling simultaneously the drive motor 4 which drives the endless belt 3, and a motor driver 39, and a thrust adjustment section 43 which adjusts a thrust direction intersecting, for example perpendicular to a rotating direction of a rotating body 41, with a position detection control circuit 37.

In addition, if the position and the speed of the rotating body are detected from the output of the rotary encoder which includes the disk-shaped scale illustrated in FIG. 16, and the drive device is controlled, it is possible to perform the rotation control with a high accuracy.

Moreover, if the position and the speed of the rotating body are detected from the output of the rotary encoder which includes the disk-shaped scale illustrated in FIG. 16, and the drive device is controlled, and a thrust adjustment device which adjusts a thrust direction intersecting, for example perpendicular to a rotating direction of the rotating body is used, it is possible to perform the rotation control of the belt and the thrust adjustment simultaneously.

According to an aspect of the present invention, by comparing an amount of light received, detection in a sub moving direction can be performed easily, and it is possible to detect eccentricity of a rotary encoder, approach position of a linear scale and meandering.

According to a preferable embodiment of the present invention, it is possible to perform detection in the sub moving direction easily even with a low-cost line sensor of one-dimension being used as the image pickup device.

According to another preferable embodiment of the present invention, due to a line pattern having a certain width being used, it is possible to perform a measurement with a good accuracy without irregular signal strength in the sub moving direction.

According to a further preferable embodiment of the present invention, it is possible to perform a measurement with good sensitivity by detecting a difference signal between signals of right and left image pickup devices.

According to a further preferable embodiment of the present invention, with such a structure in which an image sensor having a 2×n-pixel structure is employed and right and left ends of a mark pattern are imaged by an optical system, it is possible to improve measuring sensitivity easily.

According to a further preferable embodiment of the present invention, even if a two-dimensional sensor is employed, it is possible to decrease the calculation amount to perform a high-speed measurement by using a sum of amount of light received by pixels from a center to right and left sides.

According to a further preferable embodiment of the present invention, it is easy to connect with a general measurement device and a motor controller by outputting an encoder signal.

According to a further preferable embodiment of the present invention, due to eccentricity of a scale disk of the rotary encoder being able to be measured, it is possible to perform a correction on a measuring error even if there is attached eccentricity of the scale disk.

According to a further preferable embodiment of the present invention, due to surface speeds of a belt and a cylindrical surface being able to be measured, it is possible to perform a carrier control with a high accuracy.

According to a further preferable embodiment of the present invention, it is possible to perform a drive control of a rotation angle speed of a cylinder body which is used for a latent image carrier in an image forming device, with a high accuracy.

According to a further preferable embodiment of the present invention, it is possible to perform an approach control (a thrust direction control) and a carrying speed control in an endless carrier device such as an image carrier (an intermediate transfer belt) in the image forming device simultaneously.

According to a further preferable embodiment of the present invention, it is possible to carry out an approach control by performing a measurement of an approach direction, in addition to the approach control, by carrying out a travel control of a rotating body in the image forming device, and a highly accurate position adjustment is possible with compensation of latent image forming timing or latent image data, etc., even if a mechanism control is not performed.

It should be noted that although the present invention has been described with respect to exemplary embodiments, the invention is not limited thereto. In view of the foregoing, it is intended that the present invention cover modifications and variations provided they fall within the scope of the following claims and their equivalent.

The entire contents of Japanese patent application No. JP 2006-345052, filed on Dec. 21, 2006, of which the convention priority is claimed in this application, are incorporated hereinto by reference.

What is claimed is:

1. A position detection device, comprising:
a scale; and
an image pickup device which is configured to capture a mark pattern of the scale formed with a consecutive mark pattern generated by a change in prescribed reflectivity or permeability,
the mark pattern of the scale being formed with substantially identical mark patterns which are disposed in a main moving direction of the scale continuously, and the mark pattern being arranged such that a part of the mark pattern in a sub moving direction intersecting with the main moving direction is projected, when the mark pattern is projected on the image pickup device,
the position detection device being configured to detect a moving position of the scale by capturing the mark pattern of the scale with the image pickup device.

2. A position detection device according to claim 1, wherein the image pickup device includes a line sensor having a plurality of light receiving elements arranged continuously, and the light receiving elements are arranged such that an arrangement direction of the light receiving elements on the line sensor is substantially identical with the main moving direction of the scale.

3. A position detection device according to claim 1, wherein the mark pattern of the scale includes a plurality of line patterns each of which has a certain width.

4. A position detection device according to claim 1, wherein a plurality of image pickup devices are provided in the sub moving direction of the scale.

5. A position detection device according to claim 1, wherein the image pickup device includes a plurality of light receiving areas in the sub moving direction of the scale, and a light receiving optical system is configured to receive light from each of both ends in the sub moving direction of the mark pattern of the scale.

6. A position detection device according to claim 1, wherein the image pickup device includes a two-dimensional image sensor, and an imaging range of the two-dimensional image sensor is larger than a length of the mark pattern of the scale in the sub moving direction.

7. A position detection device according to claim 1, wherein the position detection device includes a signal processing section which is configured to perform signal processing on an output of the image pickup device, and output a pulse signal of an AB phase with a phase difference of 90 degrees.

8. A position detection device according to claim 2, wherein the position detection device includes a signal processing section which is configured to perform signal processing on an output of the image pickup device, and output a pulse signal of an AB phase with a phase difference of 90 degrees.

9. A position detection device according to claim 3, wherein the position detection device includes a signal processing section which is configured to perform signal processing on an output of the image pickup device, and output a pulse signal of an AB phase with a phase difference of 90 degrees.

10. A position detection device according to claim 4, wherein the position detection device includes a signal processing section which is configured to perform signal processing on an output of the image pickup device, and output a pulse signal of an AB phase with a phase difference of 90 degrees.

11. A position detection device according to claim 5, wherein the position detection device includes a signal processing section which is configured to perform signal processing on an output of the image pickup device, and output a pulse signal of an AB phase with a phase difference of 90 degrees.

12. A position detection device according to claim 6, wherein the position detection device includes a signal processing section which is configured to perform signal processing on an output of the image pickup device, and output a pulse signal of an AB phase with a phase difference of 90 degrees.

13. A position detection device according to claim 1, wherein the scale includes a mark pattern which is formed in a radial direction on a disk-shaped scale.

14. A position detection device according to claim 2, wherein the scale includes a mark pattern which is formed in a radial direction on a disk-shaped scale.

15. A position detection device according to claim 3, wherein the scale includes a mark pattern which is formed in a radial direction on a disk-shaped scale.

16. A position detection device according to claim 4, wherein the scale includes a mark pattern which is formed in a radial direction on a disk-shaped scale.

17. A position detection device according to claim 5, wherein the scale includes a mark pattern which is formed in a radial direction on a disk-shaped scale.

18. A position detection device according to claim 6, wherein the scale includes a mark pattern which is formed in a radial direction on a disk-shaped scale.

19. A rotating body travel device, including:
a position detection device;
a drive device which is configured to drive the rotating body;
a thrust adjustment device which is configured to adjust a thrust direction intersecting with a rotating direction of the rotating body; and
a control device which is configured to control the drive device and the thrust adjustment device according to a detection result by the position detection device,
the position detection device comprising:
a scale; and
an image pickup device which is configured to capture a mark pattern of the scale formed with a consecutive mark pattern generated by a change in prescribed reflectivity or permeability,
the mark pattern of the scale being formed with substantially identical mark patterns which are disposed in a main moving direction of the scale continuously, and the mark pattern being arranged such that a part of the mark pattern in a sub moving direction intersecting with the main moving direction is projected, when the mark pattern is projected on the image pickup device,
the position detection device being configured to detect a moving position of the scale by capturing the mark pattern of the scale with the image pickup device.

20. An image forming device, including a position detection device comprising:
a scale; and
an image pickup device which is configured to capture a mark pattern of the scale formed with a consecutive mark pattern generated by a change in prescribed reflectivity or permeability,
the mark pattern of the scale being formed with substantially identical mark patterns which are disposed in a main moving direction of the scale continuously, and the mark pattern being arranged such that a part of the mark pattern in a sub moving direction intersecting with the main moving direction is projected, when the mark pattern is projected on the image pickup device,
the position detection device being configured to detect a moving position of the scale by capturing the mark pattern of the scale with the image pickup device.
